(19) United States
(12) Patent Application Publication
(10) Pub. No.: US 2015/0092424 A1
(43) Pub. Date: Apr. 2, 2015

(54) Light-emitting diode luminaire with dynamic convection cooling

(71) Applicant: Sergey Yuryevich Bibikov, Saint-Petersburg (RU)

(72) Inventor: Dmitriy Aleksandrovich Smolin, Leningradskaya reg. (RU)

(21) Appl. No.: 14/399,369

(22) PCT Filed: Feb. 26, 2013
(86) PCT No.: PCT/RU2013/000153

§ 371 Date: Nov. 6, 2014

(30) Foreign Application Priority Data
Sep. 6, 2012 (RU) 2012138177

(51) Int. Cl. F21V 29/00; F21V 15/01

(52) U.S. Cl. CPC F21V 29/004; F21V 15/011
USPC 362/373

(57) ABSTRACT

The invention relates to the field of lighting, and specifically to a lighting devices and/or light sources with semiconductor device—light emitting diodes and can be used as an LED light source for outdoor, industrial, domestic and architectural lighting design. The task to be solved by the claimed technical solution is to create a simple to manufacture high-efficiency lighting device. Technical results achieved as a result of solving the problem, consist in: increase efficiency of the device, increasing the lifetime of the device, simplifying device manufacture. The LED luminaire with dynamic cooling convection comprises at least one hollow housing of a thermally conductive material on the outer surface of which is secured LED light source that is connected to a power source. The housing is a segment of a hollow pipe with open ends and the LED light source, for which the LED module is used, is installed in close proximity to one of the open ends of the housing. In some cases of implementation LED module can be mounted on side surface of housing. In some cases of implementation LED module can be secured at the end surface of the housing for entry of air into the interior of the housing. In various cases, the implementation of LED module may be secured to the housing surface via a releasable or permanent connection. Preferably, that between the surfaces of the LED module and the housing was placed a layer of thermally conductive paste material. In some cases of implementation the LED luminaire may comprise n structurally interconnected hollow housings, where n≧2, each of which represents a segment of a hollow pipe with open ends; in close proximity to one of which the LED module is installed. In various cases of implementation the housings of two or more fixtures can be connected to each other via a releasable or permanent connection. In various cases of implementation the housings of two or more fixtures can be connected by means of a rigid or swivel. In some cases of implementation the housings of two or more fixtures can be connected to each other so that their longitudinal axes are parallel to each other. In other cases of implementation the housings of two or more lamps may be connected to each other so that their longitudinal axes lie in one another at an angle of range 10°-170°. In some cases, the housings of the two or more luminaires are interconnected via adjacent contact surfaces. In some cases, the housings of the two or more luminaires are interconnected with a gap between adjacent surfaces. In various cases, each of the housings may have a rectangular or square, or round, or triangular, or shaped profile. Preferably, that the housing is made of an aluminum pipe of rectangular shape with exterior dimensions of width—100.0 mm, the height—30.0 mm, with a wall thickness of 2.0 mm. Preferably, the length of the body is in the range of 0.2 m-0.5 m. Preferably, the power LED module is in the range of 20-70 watts. Preferably, the LED luminaire comprises means for fastening to the supporting surface.

### BACKGROUND OF THE INVENTION

### Field of the Invention

The invention relates to the field of lighting, and specifically to a lighting devices and/or light sources with semiconductor device—light emitting diodes.

The invention can be used as an LED light source for outdoor, industrial, domestic and architectural lighting design.

### Definition of Terms

LED or light emitting diode (LED, LED, LED English. Light-emitting diode)—a semiconductor device with an electronic pn junction, which creates the optical radiation by passing electric current through it (http://ru.wikipedia.org/wiki/C [symbol] ).

LED Module—a printed circuit board—PCB with LEDs mounted on it, and possibly electronic components and secondary optics (http://light.rtcs.ru/products/list.php?SECTION_ID=89). LED modules (clusters) are sealed units of high-impact polystyrene with LEDs located inside. (http://nlt-trading.ru/catalog/index.php?SECTION_ID=4).

LED lighting devices have several advantages—high luminous efficiency, low power consumption, long service life, high security, compactness and light weight, resistance to mechanical stress, the purity of light, radiation directivity and others.

### Description of the Related Art

Known LED lighting—lamp containing sections of LEDs connected to the power supply, which is connected to the mains alternating voltage, where as a heatsink used luminaire housing made of a thermally conductive material, the section of LEDs mounted on the heatsink.

As the radiator cooling unit—heatsink can be used a block of metal elements located both on the housing and inside the housing, and to increase the heat dissipated by the power LED heatsink may have forced cooling, for example by means of blower (RF patent number 2,313,199 for an invention “Lamp” IPC H05B33/02, F21S4/00, publ. 20 Dec. 2007). The disadvantage of this lamp is the inefficient heat removal-dissipation at high thermal loads, which leads to reduction of lifetime of the lamp.

Known lamp containing an LED light source, as well as membrane blower motor, placed in the housing, which having the nozzle openings and a hollow radiator, where the outer surface of radiator is provided with cooling fins, wherein the radiator and the fan housing are installed so that the radiator intercostal spaces form channels for the air flow generated by the fans and discharged through the nozzle openings of the housing. The fan housing and a light source situated in the radiator cavity, when the lamp comprises installed over a radiator a tubular closed at the top housing, in the bottom and top parts of which are made through openings (RF patent number 111253 for the utility model “lamp with active cooling,” IPC F21V29/02 , publ. 10 Dec. 2011). The disadvantage of this lamp is its structural complexity and lack of operational reliability.

The closest known with respect to the essential features of the claimed invention and selected as a prototype LED lamp of convection cooling, comprising the hollow housing of a thermally conductive material on the outer surface of which is mounted LED light source that is connected to the power supply via flexible cable. Optical lens covering the LEDs has an annular shape; the body-housing is the radiator and has a vertical radiator grille (RF patent number 2,433,577 for the invention “LED lamp with high efficiency convection cooling,” IPC H05B33/00, publ. 10 Nov. 2011). Performing the outer side surface of the housing ribbed in the form of vertical ribs gratings requires external machining of the preform surface by the cutter-chisel or milling, which makes manufacturing of the known lamp laborious. Furthermore, the lamp characterized by low efficiency of heat exchange between the internal volume of the hollow housing and the environment.

### SUMMARY OF THE INVENTION

The task to be solved by the claimed technical solution is to create a simple to manufacture high-efficiency lighting device.

Technical results achieved as a result of solving the problem, consist in:
increase efficiency of the device;
increasing the lifetime of the device;
simplifying device manufacture.

These technical results are achieved by the fact that our LED luminaire with dynamic cooling convection comprises at least one hollow housing of a thermally conductive material on the outer surface of which is secured LED light source that is connected to a power source. The housing is a segment of a hollow pipe with open ends and the LED light source, for which the LED module is used, is installed in close proximity to one of the open ends of the housing.

In some cases of implementation LED module can be mounted on side surface of housing.

In some cases of implementation LED module can be secured at the end surface of the housing for entry of air into the interior of the housing.

In various cases of implementation LED module may be secured to the housing surface via a releasable or permanent connection.

Preferably, that between the surfaces of LED module and the housing was placed a layer of thermally conductive paste material.

In some cases of implementation LED luminaire may comprise n structurally interconnected hollow housings, where n≧2, each of which represents a segment of a hollow pipe with open ends; in close proximity to one of which the LED module is installed.

In various cases of implementation the housings of two or more fixtures can be connected to each other via a releasable or permanent connection.

In various cases of implementation the housings of two or more fixtures can be connected by means of a rigid or swivel.

In some cases of implementation the housings of two or more fixtures can be connected to each other so that their longitudinal axes are parallel to each other.

In other cases of implementation the housings of two or more lamps may be connected to each other so that their longitudinal axes lie in one another at an angle of range 10°-170°.

In some cases, the housings of the two or more luminaires are interconnected via adjacent contact surfaces.

In some cases, the housings of the two or more luminaires are interconnected with a gap between adjacent surfaces.

In various cases, each of the housings may have a rectangular or square, or round, or triangular, or shaped profile.

Preferably, that the housing is made of an aluminum pipe of rectangular shape with exterior dimensions of width—100.0 mm, the height—30.0 mm, with a wall thickness of 2.0 mm.

Preferably, the length of the body is in the range of 0.2 m-0.5 m.

Preferably, the power LED module is in the range of 20-70 watts.

Preferably, the LED luminaire comprises means for fastening to the supporting surface.

Comparative analysis of the claimed invention with the prototype showed that in all cases of execution, it differs from the known closest technical solution:
implementation of the housing as a segment of a hollow pipe having open ends;
using LED module as LED light source;
implementation of an LED module installed in close proximity to one of the open ends of the housing.

In some cases, the invention differs from the known closest technical solution:
implementation of an LED module attached to the side surface of the housing;
implementation of an LED module attached to the end surface of the housing for entry of air into the inner cavity of the housing;
implementation of the LED module attached to the surface of the housing by means of a releasable or permanent connection;
presence of a layer of a thermally conductive paste material between the surfaces of the LED module and the housing;
the presence of n structurally interconnected hollow bodies, where n≧2;
implementation of housings interconnected via a releasable or permanent connection;
implementation of housings interconnected by rigid or swivel connection;
implementation of housings interconnected in such a manner that their longitudinal axes are parallel to each other;
implementation of housings interconnected in such a manner that their longitudinal axes
located to each other at an angle of range 10°-170°;
implementation of housings interconnected with adjacent contact surfaces;
implementation of housings interconnected with a gap between adjacent surfaces;
implementation of housing having a rectangular, or square, or circular, or triangular, or a shaped profile;
implementation of the housing of the aluminum pipe of rectangular shape with exterior dimensions of width—100.0 mm, the height—30.0 mm, with a wall thickness of 2.0 mm;
implementation of length of the housing constituting range of 0.2 m-0.5 m;
using LED module power is in the range of 20-70 watts;
the presence of the fixing means to the supporting surfaces.

The proposed design of the cooling device has improved the thermal parameters by increasing the efficiency of convective thermal exchange, which provides removal from LEDs substantially all of the heat they emit and transmitting it to the surroundings. This increases the light output of LEDs and can increase their lifetime, and consequently, the lifetime of the lighting device. In addition, more intensive cooling, allows applying to LED module higher current values, thereby increasing the efficiency of and the power of the lighting device as a whole. Using the hollow pipe as the housing does not require additional milling or other processing of the outer surface, which reduces costs and simplifies the manufacture of the product. Implementation of the lamp, containing the n number of housings, different variants of their connections allows creating lamps of different power and a design, extending the functionality and application. Execution the housing as a rectangular shape pipe with exterior dimensions of width—100.0 mm, the height—30.0 mm, with a wall thickness of 2.0 mm allows the use of varietal rolling preform substantially reducing manufacturing costs. Implementation of the housing from aluminum characterized by high thermal conductivity and heat dissipation provides effective and efficient convection cooling of the LEDs. Experimental tests have shown that when the body length from 0.2 m to 0.5 m provided the most effective cooling. When the body length is less than 0.2 m air does not have time to cool, and when the body length is more than 0.5 m, air draft between the input and output is reduced.

### BRIEF DESCRIPTION OF THE DRAWINGS

The invention is illustrated by schematic drawings of FIGS. 1-8.

FIG. 1 shows a schematic drawing of an LED luminaire with dynamic convection cooling with a rectangular housing where the LED module attached to the side surface of the housing, side view.

FIG. 2 is a view A (front) of FIG. 1

FIG. 3 is a view B (top) of FIG. 1

FIG. 4 shows a schematic drawing of the LED luminaire with dynamic convection cooling with a rectangular housing where the LED module attached to the side surface of the housing with partial incision, side view.

FIG. 5 shows a schematic drawing of the LED luminaire with dynamic convection cooling with a rectangular housing where the LED module attached to the end surface of the housing, a general view.

FIG. 6 shows a schematic drawing of the LED luminaire with dynamic convection cooling with a circular shape of the housing where the LED module attached to the side surface of the housing, the overall appearance.

FIG. 7 shows the LED luminaire with dynamic convection cooling, comprising two interconnected housings with longitudinal axis at an angle, general view.

FIG. 8 shows the LED luminaire with dynamic convection cooling, comprising four interconnected housings with the gap and with parallel longitudinal axes, general view.

### DESCRIPTION OF THE PREFERRED EMBODIMENTS

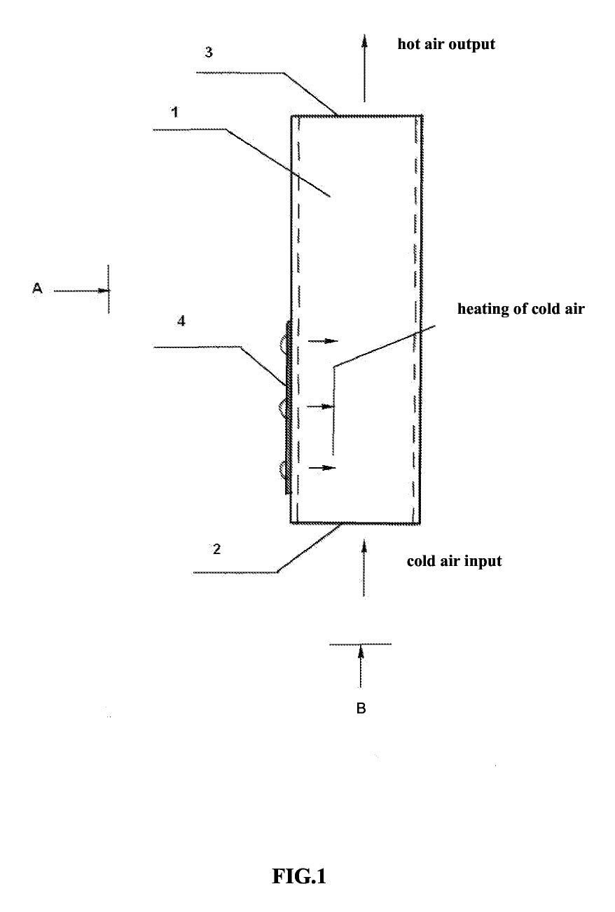

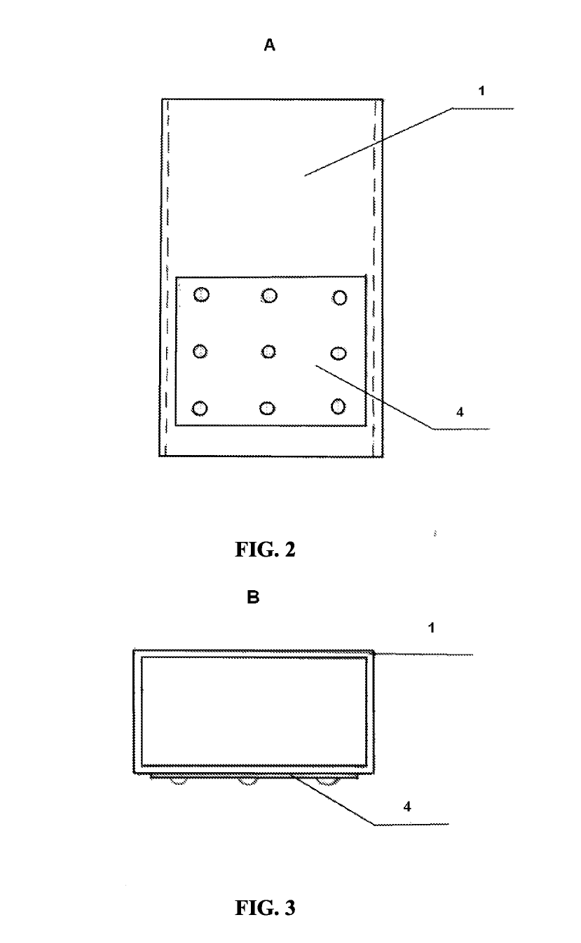

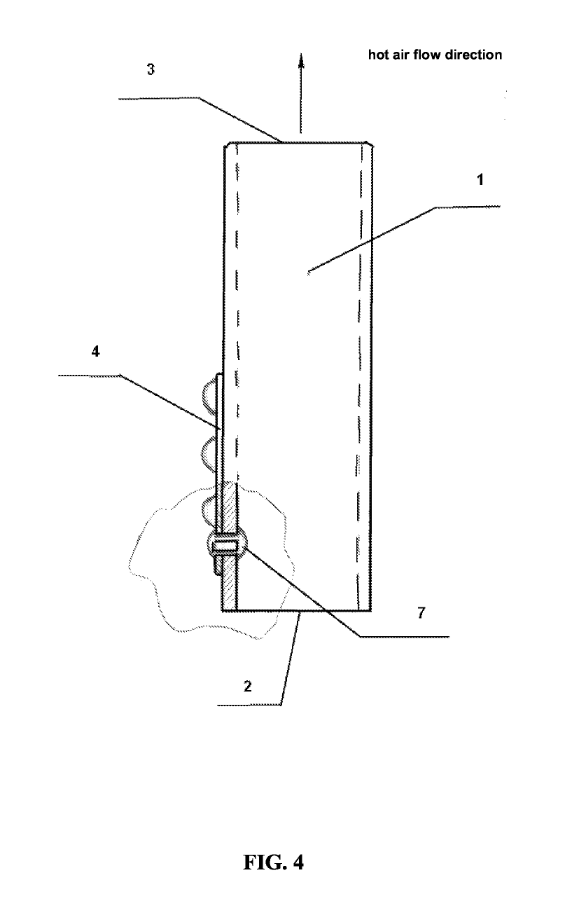

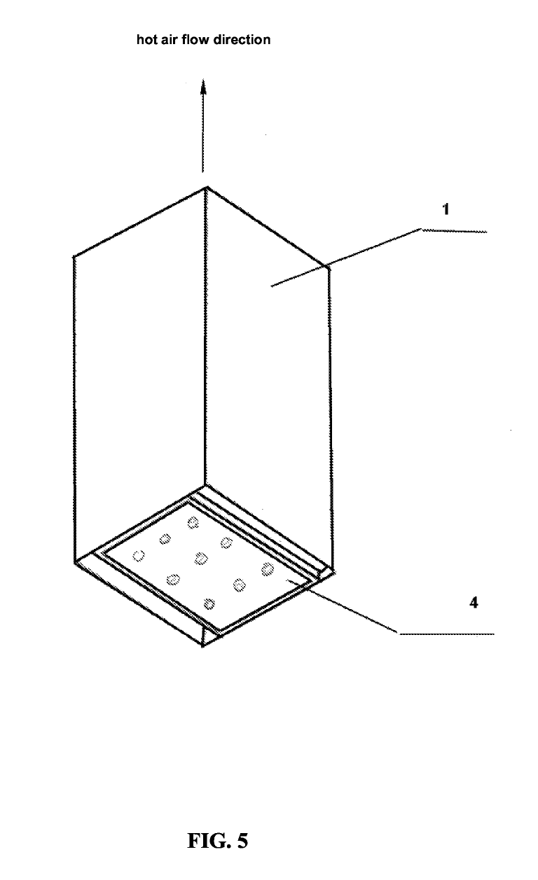

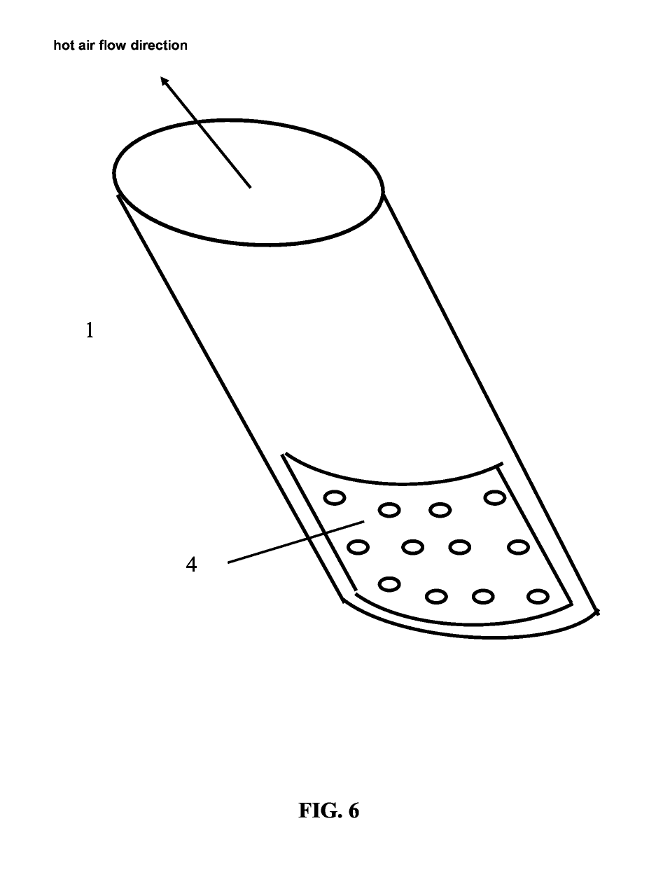

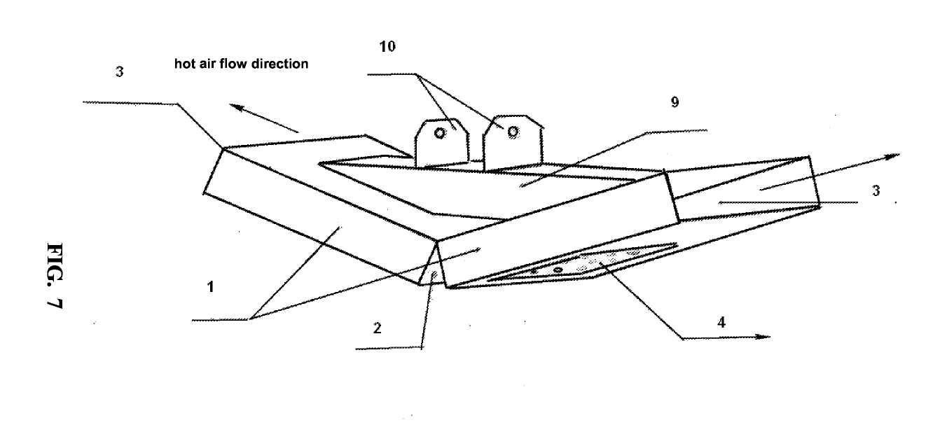

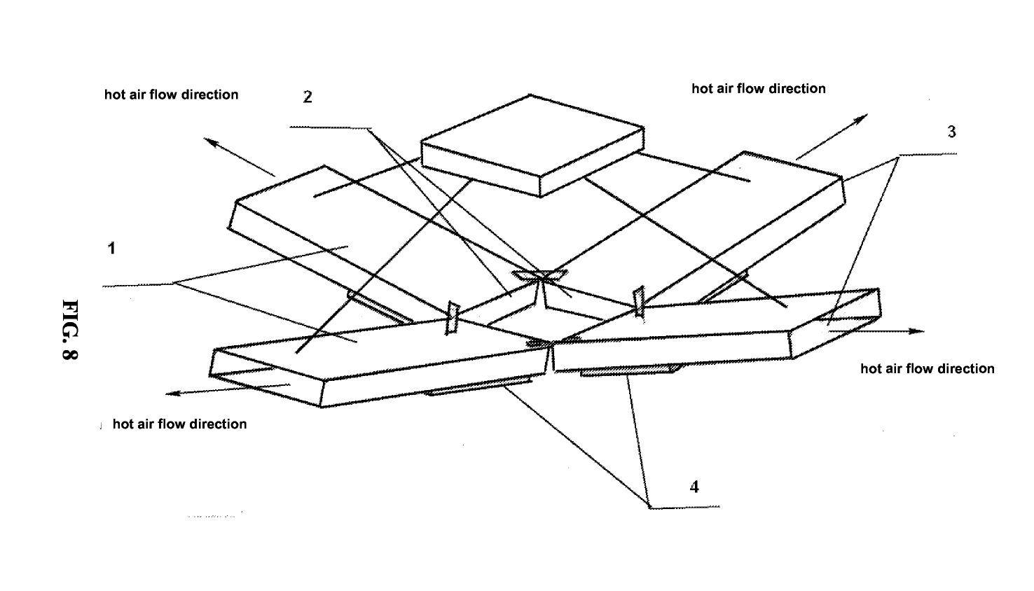

In a preferred embodiment, the LED lamp with dynamic convective cooling comprises at least one hollow housing (1) in the form of a segment of a hollow pipe of thermally conductive material with open ends (2) and (3). On the outer surface of the housing (1) in close proximity to one of the open ends (2) or (3) is attached connected to a power source (not shown) the LED module (4), which is a LED light source. In various cases of implementation LED module (4) may be secured on the side surface of the housing (1) (FIG. 1-4) or on the end surface of the housing (1) (FIG. 5) with the possibility of entry of air into the inner cavity of the housing, e.g. via holes (5). The LED module (4) can be secured on the surface of the housing (1) via a releasable connection, such as screws (6) or permanent connection, such as rivets (7) or adhesive (not shown), and so forth. Preferably, between the surfaces of the LED module (4) and the housing (1) be placed a layer of thermally conductive paste material (8) (FIG. 4). In various cases of implementation the LED luminaire can contain n (where n≧2) structurally interconnected hollow housings (1)₁, (1)₂ . . . (1)i, . . . (1)n, each of which (1)i represents a segment of a hollow pipe with open ends (2)i, (3)i, in the close proximity of one of which is mounted the LED module (4)i. Housings (1)₂ . . . (1)i, . . . (1)n, may be interconnected via a releasable (6)i or inseparable (7)i compounds. Housings can be interconnected by rigid (e.g., by welding or a connecting beam (9)), or the hinge, for example by the lever rod compound (not shown). Housings (1)₂ . . . (1)i, . . . (1)n, may be interconnected in such a manner that their longitudinal axes y arranged parallel (FIG. 9) or at the angle 10°-170° (FIG. 8) to each other; with contact by the adjacent surfaces (FIG. 1-8) or with the gap λ, between the last (FIG. 9). Housings may have rectangular shape (FIG. 1-6), or square (not shown) or round (FIG. 7) or triangular, or figure shape (not shown). A preferred embodiment of the housing (1)i of the LED luminaire of the aluminum pipe of rectangular section with exterior dimensions of width d—100.0 mm, the height h—30.0 mm, with a wall thickness s—2.0 mm. The preferred length l of the housing (1)i is in the range 0.2-0.5 m, and the power of the LED module (4)i is in the range of 20-70 watts. Preferably, that the LED luminaire comprises fastening means (10) to the mounting surface.

### INDUSTRIAL APPLICATION

The invention operates as follows. The LED module (4)i, through a layer of thermally conductive paste material (8) is attached at one of the open ends of the pipe, such as (2)i by means of a releasable (6)i or inseparable (7)i compounds. This end (2)i of the pipe becomes the input to the cold air. The opposite end (3)i of the pipe becomes the exit for the hot air. Preferably, that in the operating position the open end (2)i of the pipe in the close proximity of which installed the LED module (4)i, is placed below the level of the opposite open end (3)i of the pipe, providing slightly slanted or vertical position of the luminaire. When, through the LED module (4)i, starts to flow an electric current it is heated and through a thermally conductive composition transmits heat to the side surface of the housing (1)i, and further—into the air space inside the cavity of the housing. As a result, in the inner cavity of the housing (1)i created a difference of temperatures at the entrance (open end (2)i of the housing (1)i, and on the side surface of the housing (1)i, that is provided a natural convection. Sucked through the entrance (open end (2)i) the cold air passing through the heated by LED module airspace of the interior of the housing (1)i, it cools the LED module (4)i, and goes outside as heated through outlet (3)i.

1. The LED luminaire with dynamic convection cooling comprising at least one hollow housing made of thermally conductive material, on the outer surface of which is secured LED light source connected to a power source, wherein the housing is a segment of hollow pipe with open ends, where the LED module is used as the LED light source and installed in close proximity to one of the open ends of the housing.

2. The LED luminaire according to claim 1, wherein the LED module is secured on the side surface of the housing.

3. The LED luminaire according to claim 1, wherein the LED module is secured on the end surface of the housing for entry of air into the interior of the housing.

4. The LED luminaire according to claim 1, wherein the LED module is secured on the surface of the housing via releasable or permanent connection.

5. The LED luminaire according to claim 1, wherein in between the surfaces of the LED module and the housing is placed a layer of thermally conductive paste material.

6. The LED luminaire according to any of the claim 1, wherein it includes n, where n≧2, structurally interconnected hollow housings.

7. The LED luminaire according to claim 6, wherein the housings are interconnected by means of releasable or permanent connection.

8. The LED luminaire according to claim 6, wherein the housings are interconnected by means of rigid or hinged connection.

9. The LED luminaire according to claim 6, wherein the housings are interconnected so that their longitudinal axes are parallel to each other.

10. The LED luminaire according to claim 7, wherein the housings are interconnected so that their longitudinal axes located to each other at an angle of range 10°-170°.

11. The LED luminaire according to claim 7, wherein the housings are interconnected with the adjacent contact surfaces.

12. The LED luminaire according to claim 6, wherein the housings are interconnected with a gap between adjacent surfaces.

13. The LED luminaire according to claim 1, wherein each of the housings having a rectangular shape, or square, or circular, or triangular, or figure shape.

14. The LED luminaire according to claim 1, wherein the housing is made of an aluminum pipe of rectangular section with exterior dimensions of width—100.0 mm, the height—30.0 mm, wall thickness 2.0 mm.

15. The LED luminaire according to claim 1, wherein the length of the housing of range 0.5 m-2 m.

16. The LED luminaire according to the claim 1, wherein the output of the LED module is in the range of 20-70 W.

17. The LED luminaire according to claim 1, wherein it further comprises means for securing to the supporting surfaces.
